(19) United States
(12) Patent Application Publication
(10) Pub. No.: US 2009/0135619 A1
(43) Pub. Date: May 28, 2009

(54) COMBINATION DEVICE FOR COMBINATION OF LAMP AND BICYCLE

(75) Inventor: Tory HUNG, Taichung County (TW)

Correspondence Address: BROWDY AND NEIMARK, P.L.L.C.;624 NINTH STREET, NW, SUITE 300, WASHINGTON, DC, 20001-5303, US

(73) Assignee: Genius Electronic Optical Co., Ltd., Daya Township (TW)

(21) Appl. No.: 12/029,792

(22) Filed: Feb. 12, 2008

(30) Foreign Application Priority Data
Nov. 28, 2007 (TW) 96220143

(51) Int. Cl. B62J 6/00

(52) U.S. Cl. 362/474

(57) ABSTRACT

A combination device mounted to a bicycle handlebar for receiving a lamp includes a lamp holder and a springy member. The lamp holder is made of a plastic material and mounted to the handle bar of the bicycle, having two symmetric clamping arms. A space is formed between the two clamping arms for receiving the lamp. A predetermined interval is formed between respective distal ends of the two clamping arms. Each of the clamping arms includes a through hole and a gap in communication with the through hole and the outside of the clamping arms. The springy member is mounted to the two clamping arms, having two parts located in the through holes respectively. Accordingly, the springy member forces the two clamping arms to keep tightening the lamp for preferable positioning effect. In addition, the springy member is replaceable to elongate the working life of the combination device.

### BACKGROUND OF THE INVENTION

1. Field of the Invention

The present invention relates generally to bicycles, and more particularly, to a combination device for combination of a lamp and a bicycle.

2. Description of the Related Art

As people pay more and more attention to the recreation and the environmental protection, the bicycle has become one of the most popular vehicles for the modern people. When a user rides the bicycle at night, a lamp is usually mounted on the bicycle for illumination and premonition, so the user can know the traffic in front of him or her and the vehicles running on the opposite lane of the road are premonished. Accordingly, the lamp of the bicycle can enhance the safety of cycling.

Generally speaking, the aforesaid lamp is mounted on the bicycle via a combination holder. The combination holder includes a brace fastened tight to the handlebar of the bicycle; and a lamp bracket rotatably mounted to the brace for receiving the lamp. The brace is a discontinuous annular member having a gap and a coupling portion, defining two opposite bracing portions with respect to the gap. The two bracing portions are screwed on by a first screw bolt to approach each other, so the brace is fastened tight to the handlebar of the bicycle. The coupling portion is located at where the brace is connected with the lamp bracket. A second screw bolt runs through the coupling portion and the lamp bracket to enable the lamp bracket to be pivoted to the coupling portion, allowing the lamp bracket to turn with respect to the brace for adjustable angle of illumination of the lamp. The lamp bracket includes two symmetric clamping arms, a space formed between the two clamping arms for receiving the lamp, and an interval formed between respective distal ends of the two clamping arms. Each of the two clamping arms has a little resilience, so the two clamping arms can be forced to deform themselves via the interval to conveniently tighten the lamp.

Although the lamp can be positioned tight by the two clamping arms, the positioning effect is still limited. The aforesaid two clamping arms are subject to elastic fatigue, so the two clamping arms fail to tighten the lamp and then the lamp is apt to slip off the lamp bracket. Moreover, the brace and the lamp bracket still need the coupling portion and the second screw bolt for rotation with respect each other, so the whole structure is complicated to sophisticate and inconvenience the processing and assembly operations.

### SUMMARY OF THE INVENTION

The primary objective of the present invention is to provide a combination device for combination of a lamp and a bicycle, which is durable and can provide preferable positioning effect for the lamp.

The secondary objective of the present invention is to provide a combination device for combination of the lamp and the bicycle, which can be easily processed and quickly assembled.

The foregoing objectives of the present invention are attained by the combination device mounted to a handlebar of the bicycle for receiving the lamp. The combination device is composed of a lamp holder and a springy member. The lamp holder is made of a plastic material and mounted to the handle bar of the bicycle, having two symmetric clamping arms. A space is formed between the two clamping arms for receiving the lamp. A predetermined interval is formed between respective distal ends of the two clamping arms. Each of the clamping arms includes a through hole and a gap in communication with the through hole and the outside of the clamping arms. The springy member is mounted to the two clamping arms, having two parts located in the through holes respectively.

In light of the above, the springy member forces the two clamping arms to keep tightening the lamp for preferable positioning effect. In addition, the springy member is replaceable to elongate the working life of the combination device.

### BRIEF DESCRIPTION OF THE DRAWINGS

FIG. 1 is a perspective view of a preferred embodiment of the present invention.

FIG. 2 is a schematic perspective view of the preferred embodiment of the present invention in combination with the lamp and the bicycle.

FIG. 3 is a side view of the preferred embodiment of the present invention.

FIG. 4 is a sectional view taken along a line 4-4 indicated in FIG. 3.

### DETAILED DESCRIPTION OF PREFERRED EMBODIMENTS

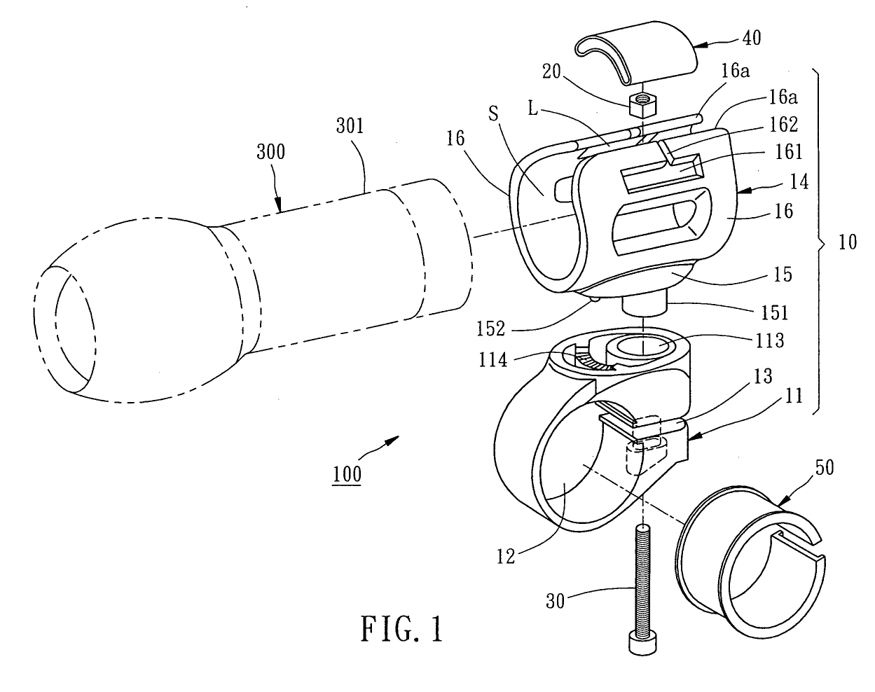

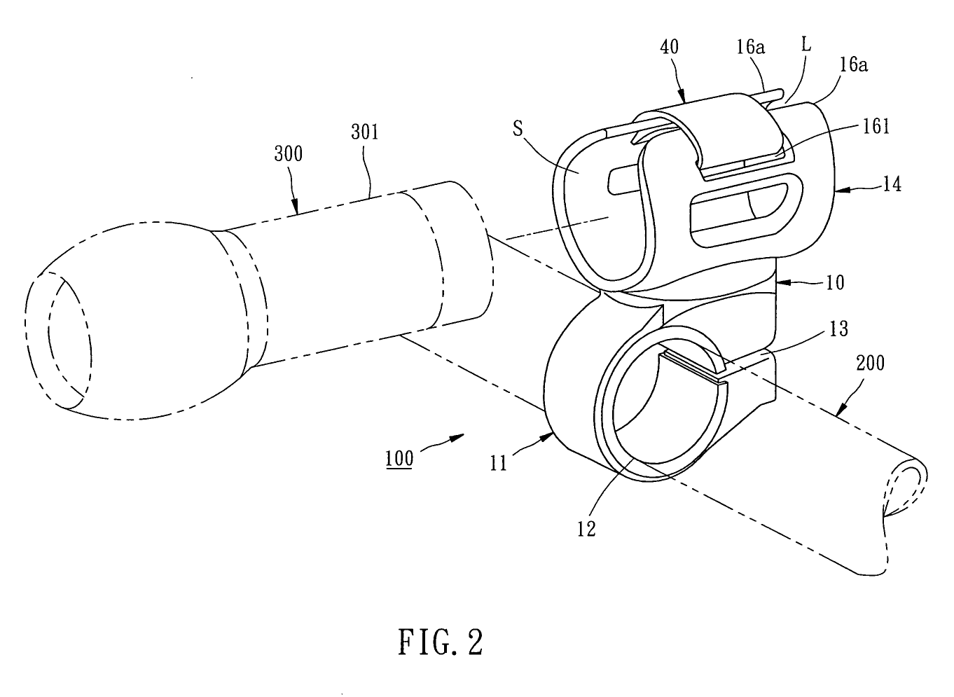

Referring to FIGS. 1-4, a combination device 100 of a preferred embodiment of the present invention for combination of a bicycle handlebar 200 and a lamp 300 is composed of a lamp bracket 10, a screw nut 20, a screw bolt 30, a springy member 40, and a non-skid washer 50.

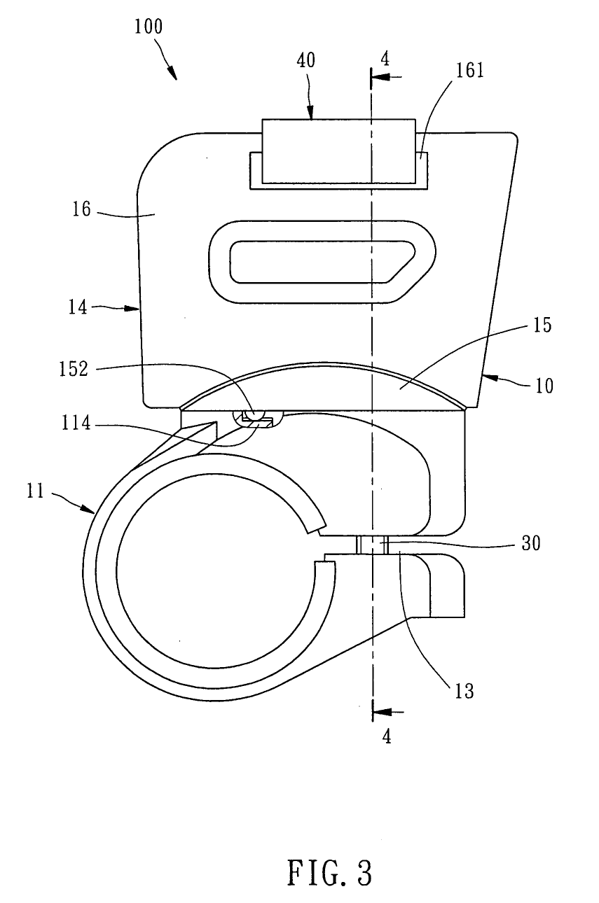

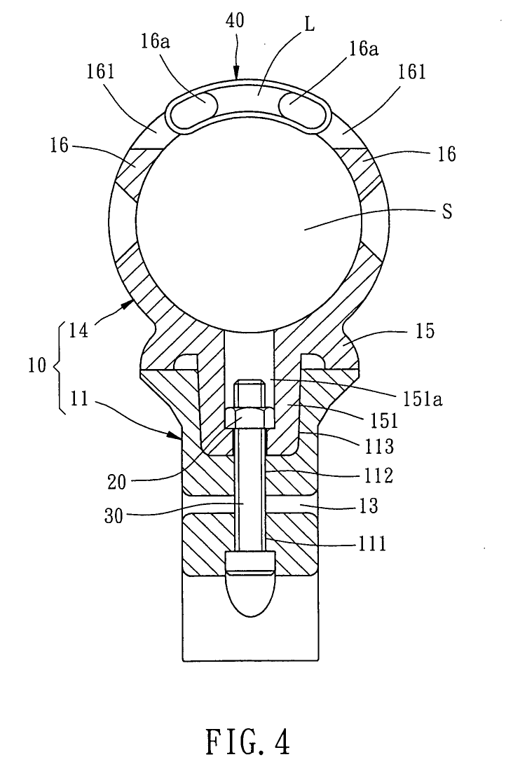

The lamp bracket 10 is made of a plastic material, having a base holder 11 and a lamp holder 14, which are rotatable with respect to each other. The base holder 11 includes a combination hole 12 for receiving the bicycle handlebar 200, a breach 13 in communication with the combination hole 12 and the outside thereof, and a first through hole 111 and a second through hole 112, both of which are in communication with the breach 13. Referring to FIGS. 1 and 4 again, the base holder 11 includes a cavity 113 and an arched toothed portion 114. The cavity 113 are in communication with the second through hole 112 and the outside of the base holder 11. The arched toothed portion 114 is located at one side of the cavity 113 and coaxial with the second through hole 112. The lamp holder 14 includes a combination portion 15 and two symmetric claming arms 16 connected with the combination portion 15 in one piece. Each of the two symmetric claming arms 16 has a distal end 16a. The combination portion 15 has a lug 151 and a rib 152. The lug 151 is mounted into the cavity 113 of the base holder 11, having a third through hole 151a in communication with the second through hole 112. Referring to FIG. 3 again, the rib 152 and the arched toothed portion 114 are stopped against each other to hold the base holder 11 in a position relative to the lamp holder 14. A space S is formed between the two clamping arms 16 for receiving the lamp 300. A predetermined interval L is defined between the respective two distal ends 16a of the clamping arms 16. In this embodiment, each of the clamping arms 16 has a slot 161 and a gap 162. The slot 161 and the gap 162 of each clamping arm 16 are close to the distal end 16a. The gaps 162 are in communication with the slot 161 and the outside of the clamping arms 16.

Referring to FIG. 4 again, the screw nut 20 is mounted into the third through hole 151a of the lug 151, and the screw bolt 30 is inserted in sequence through the first through hole 111, the second through hole 112, and the third through hole 113 to be connected with the screw nut 20, such that the lamp holder 14 is rotatable with respect to the base holder 11. In light of this, screwing on or off the screw bolt 30 can adjust the size of the breach 13 of the base holder 11 to further adjust the diameter of the combination hole 12 and to fasten the base holder 11 to the bicycle handlebar 200.

It is to be noted that how the base holder 11 is connected with the lamp holder 14 is not limited to their relative rotation. In other words, the base holder 11 and the lamp holder 14 can be alternatively formed in one piece to be not rotatable with respect to each other.

The springy member 40 is hollow and arched to have two openings at two ends thereof and is made of an elastic material. The springy member 40 can be deformably squeezed through the gaps 162 into the slots 161 respectively to be mounted to the two clamping arms 16, keeping the two clamping arms 16 being tightened. Specifically, when elastic fatigue happens for the two clamping arms 16, the springy member 40 still forces the two clamping arms 16 to approach each other to maintain the interval L, thus preventing the lamp 300 from slipping off the lamp holder 14. Besides, when the lamp 300 is located in the space S of the lamp holder 10, the springy member 40 contacts an external periphery of the lamp 300 to position the lamp 300 diametrically and axially. However, the springy member 40 does not have to contact the external periphery of the lamp 300. In other words, the springy member 40 can also be mounted to the two clamping arms 16 without contacting the lamp 300 in such a way that the two clamping arms 16 are forced to maintain tightened to hold the lamp 300 tight.

The non-skid washer 50 is made of rubber and is a discontinuous annular member mounted to the sidewall of the combination hole 12. Because the non-skid washer 50 is elastic, it can structurally strengthen the combination of the base holder 11 and the bicycle handlebar 200. It is to be noted that the non-skid washer 50 is not the essential element of the present invention and thus it can be omitted.

In light of the above structures, the springy member 40 holds the two clamping arms 16 to strengthen the positioning effect for the lamp 300. Because the material (rubber) that the springy member 40 is made is elastic, when the springy member 40 contacts the external periphery 301 of the lamp 300, the friction force between the springy member 40 and the lamp 300 enhances the axial positioning effect for the lamp 300. Besides, the springy member 40 is deformable while forced, so that it is convenient for replacement of the springy member 40. In other words, replacing the springy member 40 can recover the positioning effect of the combination device 100 for the lamp 300. As for the conventional combination holder, if the clamping arms fail to hold the lamp tight when the elastic fatigue happens, it will be necessary to replace the whole combination holder. In this regard, the present invention can reduce more cost than the conventional combination holder can. Furthermore, the lamp bracket 10 of the present invention, compared with the conventional lamp holder in the structure of rotation, is more structurally simplified, of easier processing, and of quicker assembly because the lamp holder 14 can be rotated with respect to the base holder 11 in such the simple way that the screw bolt 30 screwing on/off the base holder 11 is inserted through both of the base holder and the lamp holder 14.

Although the present invention has been described with respect to a specific preferred embodiment thereof, it is no way limited to the details of the illustrated structures but changes and modifications may be made within the scope of the appended claims.

1. A combination device for combination of a lamp and a bicycle handlebar, comprising:
a lamp holder made of a plastic material and mounted to said bicycle handlebar, said lamp holder having two symmetric clamping arms, a space formed between said two clamping arms for receiving said lamp, and a predetermined interval defined between respective distal ends of said clamping arms, each of said clamping arms having a slot and a gap in communication with said slot and an outside of said clamping arms; and
a springy member mounted to said clamping arms and located in said two slots.

2. The combination device as defined in claim 1, wherein said springy member contacts an external periphery of said lamp when said lamp is located in said space of said lamp holder.

3. The combination device as defined in claim 1, wherein said lamp holder comprises a base holder and a lamp holder connected with said base holder, said base holder being connected to said bicycle handlebar, said lamp holder having a combination portion and said two clamping arms connected with said combination portion in one piece, said lamp holder being connected with said base holder via said combination portion.

4. The combination device as defined in claim 3 further comprising a screw bolt and a screw nut, wherein said base holder has a combination hole for receiving said bicycle handlebar, a breach in communication with said combination hole and an outside of said base holder, and a first through hole and a second through hole, both of which are in communication with said breach; said combination portion of said lamp holder has a third through hole for receiving said screw nut, said screw bolt being inserted in sequence through said first, second, and third through holes to be connected with said screw nut.

5. The combination device as defined in claim 4, wherein said base holder comprises a cavity and an arched toothed portion, said cavity being communication with said second through hole and the outside of said base holder, said arched toothed portion being axial with said second through hole; said combination portion of said lamp holder comprises a lug and a rib, said lug having said third through hole and mounted into said cavity of said base holder, said rib contacting said arched teethed portion.

6. The combination device as defined in claim 5 further comprising a non-skid washer mounted to a sidewall of said combination hole of said base holder.
